(19) United States
(12) Patent Application Publication
(10) Pub. No.: US 2013/0041975 A1
(43) Pub. Date: Feb. 14, 2013

(54) Distributed media access

(71) Applicants: Nathalie Pham, Houston, TX (US); Muhammad Zakria, Faisalabad (PK)

(72) Inventors: Nathalie Pham, Houston, TX (US); Muhammad Zakria, Faisalabad (PK)

(21) Appl. No.: 13/136,800

(22) Filed: Aug. 10, 2011

(51) Int. Cl. G06F 15/16

(52) U.S. Cl. 709/217

(57) ABSTRACT

A method is disclosed for delivering enhanced distributed media. The method entails accepting a request, analyzing a device header, publishing a playlist to a user, and redirecting the user to a published playlist in cloud storage. The method further involves retrieving the frame sequence defined in the device header, calling frames in order according to the frame sequence, and then, posting video defined by frames.

### PRIORITY

This application claims the benefit of U.S. Provisional Application Ser. No. 61/371,751, filed Aug. 9, 2010.

### BACKGROUND

The present invention relates to systems, methods, and products for distributed media access, including, more particularly, network-based delivery of media.

Prior art streaming architectures and methods have been employed to deliver media via network. Many of these prior art devices have, however, proven cumbersome to use, bandwidth intensive, and unreliable in circumstances of low bandwidth. In particular, when transferring a media stream over a connection that cannot provide the necessary throughput, several undesirable effect arise. For example, a network buffer may overflow, resulting in packet loss, causing garbled video or audio playback; or a media player buffer may underflow resulting in playback stall.

### SUMMARY

The present invention relates to distributed media access, including, more particularly, network-based delivery of media. Aspects of the invention include enhanced distributed content delivery via a network. Other aspects include web-based media delivery, such as, for example, media delivery via web browser. Other aspects include networked camera solutions integrated with enhanced media publishing for camera control and upload parameter modification according to detected network conditions.

In one general embodiment, content may be fragmented for storage and delivery from multiple distributed nodes. Fragmentation may be implemented in a variety of ways and carried out in various sizes and formats to provide optimally conditioned fragments for improved content delivery across a wide range of projected network conditions. Some embodiments may involve generating copies of content fragments in multi-coded formats for distribution and consumption worldwide across a wide range of network conditions. Distribution may include multi-threaded delivery from cloud file storage region points.

One general embodiment includes a system comprising one or more servers configured to deliver content over a network to a client on a client device in communication with the server(s). The content may include various media in one or more of several formats. The content may be generated from an application program, which may be executable program code running on the server or other computer in communication with the server. In some implementations, the application program may comprise an originating client on an originating client device, or may receive content from an originating client, either directly or indirectly. Alternatively, content may also be received from other nodes or retrieved from storage. One or more servers may be configured to capture the content (e.g., computer-generated output from the application program), process the captured output, and transmit the processed output to the client device. Alternatively, the server may store the processed output for later transmission to the client device. In specific embodiments, a first server may capture and process the content, and a second server may transmit the processed output to the client device. In some cases, the processed output may be transmitted after being stored by either the first or second server.

The server may be configured to process the captured output to achieve constant or relatively constant quality of variable bit rate output upon transmission to the client. The client may be configured to receive transmitted converted output and execute, decode, and/or render graphics, video, and/or audio on the client device. The server may be further configured to process the captured output in order to provide either compressed file size or lower overall average bit rate at low latency. The data may be partitioned into variable-size chunks.

Processing may include converting sequences of frame set time blocks in multi-threaded encoding sequences in accordance with multiple formats such as Windows Media Video (‘WMV’), Flash Video (‘FLV’), 3GPP, M3U (m3u8), Moving Picture Experts Group (‘MPEG’), and the like through the use of one or more encoders. An encoder may publish video codec data of converted output in parallel.

Processing may further include configuring multi-pass variable bit rate control of data segmentation, splicing of file packet size into intervals of frame set time blocks, and so on. The server may be configured to control encoding parameters to produce output of relatively constant quality. An encoder may set checkpoints in the second pass to adjust the control parameters and/or subsequent checkpoints. An encoder may define peak bit rate constraints to limit peak bit rate in accordance with client device screen architecture parameters. An encoder may store auxiliary information from earlier passes for use in later passes to increase the performance of the later passes (e.g., to decrease processing time); perform signature encryption of input data and intercept user input decryption to check consistency between passes; and transmit the intercepted user region-defined publishing point of the cloud file storage server over the network internet protocol.

One aspect of the invention includes a scalable architecture for delivery of real-time video packet data sent over a communication network. A control mechanism may be embedded in the architecture to provide for the management and administration of users who are to receive the real-time video packet data.

Aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a module. Embodiments of the invention may be implemented as any viable computing device including logic and memory, or software modules including computer program instructions executed thereon, as will occur to one of ordinary skill in the art, including devices where logic is implemented as field-programmable gate arrays (‘FPGAs’), application-specific integrated circuits (‘ASICs’), and the like.

Aspects of the present invention are described below with reference to flowchart illustrations of methods, devices, and computer program products according to embodiments of the invention. Each block of the flowchart illustrations (or combinations of blocks in the flowchart illustrations) can be implemented by computer program instructions provided to a processor of a special purpose computer or other programmable data processing apparatus for execution to implement the functions specified in the flowchart blocks. These computer program instructions may also be stored in a computer readable medium, such that the instructions stored in the computer readable medium produce an article of manufacture including instructions which implement the functions specified in the flowchart blocks.

Aspects of the present invention are described below with reference to flowchart illustrations of methods, devices, and computer program products according to embodiments of the invention. Each block of the flowchart illustrations (or combinations of blocks in the flowchart illustrations) can be implemented by computer program instructions provided to a processor of a special purpose computer or other programmable data processing apparatus for execution to implement the functions specified in the flowchart blocks. These computer program instructions may also be stored in a computer readable medium, such that the instructions stored in the computer readable medium produce an article of manufacture including instructions which implement the functions specified in the flowchart blocks.

Other embodiments may include a controller for enhancing distributed content delivery. The controller may include circuits configured to facilitate enhancing distributed content delivery. The controller may include programmed logic circuit for enhancing distributed content delivery. The programmed logic circuit may be adapted to capture media content output and encode segmented media.

Other embodiments of the present invention include a design structure embodied in a machine readable storage medium for at least one of designing, manufacturing, and testing a design. The design structure may include the controller for enhanced media delivery, constituent modules or circuits thereof, or constituent modules or circuits of the apparatus. The design structure may include a netlist which describes the controller, apparatus, or constituent modules or circuits. The design structure may reside on the machine readable storage medium as a data format used for the exchange of layout data of integrated circuits.

Other embodiments of the present invention include computer program products embodied in one or more computer readable media having computer readable program code disposed thereon. These computer program products may include computer program code adapted to carry out the methods of the present invention on one or more data processing system (computer).

Other general embodiments include a system comprising one or more data processing systems. The data processing systems comprise a processor and a computer memory operatively coupled to the processor. The computer memory has disposed within it computer program instructions for execution on the processor to implement one or more of the method embodiments described above. Other embodiments include computer program products disposed on a computer readable medium comprising computer program instructions for carrying out one or more of the method embodiments described above by their execution on a computer processor.

The foregoing and other objects, features and advantages of the disclosure will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

The following figures are part of the present specification, included to demonstrate certain aspects of embodiments of the present disclosure and referenced in the detailed description herein.

FIG. 1A is a simplified flow diagram illustrating aspects of one embodiment according to the invention;

FIG. 1B is yet another simplified flow diagram illustrating aspects of one embodiment according to the invention;

FIG. 2 is a simplified illustration for enhanced distributed content delivery in accordance with one embodiment of the invention;

FIG. 3 is a simplified block diagram of an exemplary computer embodying aspects of the invention;

FIG. 4A is a simplified diagram illustrating an exemplary method for enhanced distributed media delivery according to the invention;

FIG. 4A is a simplified diagram illustrating another exemplary method for enhanced distributed content delivery according to the invention;

FIG. 4A is a simplified diagram illustrating an exemplary method for enhanced distributed content delivery according to the invention; and

FIG. 5 is a simplified diagram of graphical display in accordance with the present invention.

### DETAILED DESCRIPTION

The principles of the invention are explained by describing in detail, specific example embodiments of devices, products, and methods for distributed media delivery, including, more particularly, network-based delivery of media. Those skilled in the art will understand, however, that the invention may be embodied as many other devices, products, and methods. For example, various aspects of the methods and devices may be applied to other content, advertising, or data. Many modifications and variations will be apparent to those of ordinary skill in the art. Embodiments were chosen and described in order to best explain the principles of the invention and the practical application, and to enable others of ordinary skill in the art to understand the invention for various embodiments with various modifications as are suited to the particular use contemplated. The scope of the invention is not intended to be limited by the details of exemplary embodiments described herein. The scope of the invention should be determined through study of the appended claims.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, implement the functions/acts specified in the flowchart and/or block diagram block(s).

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block(s).

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block(s).

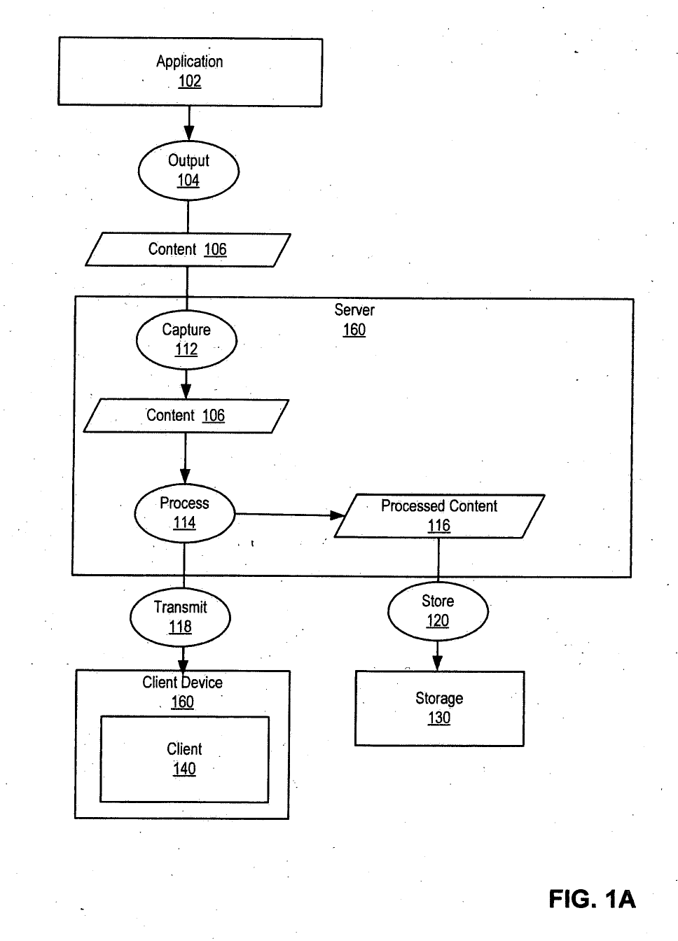

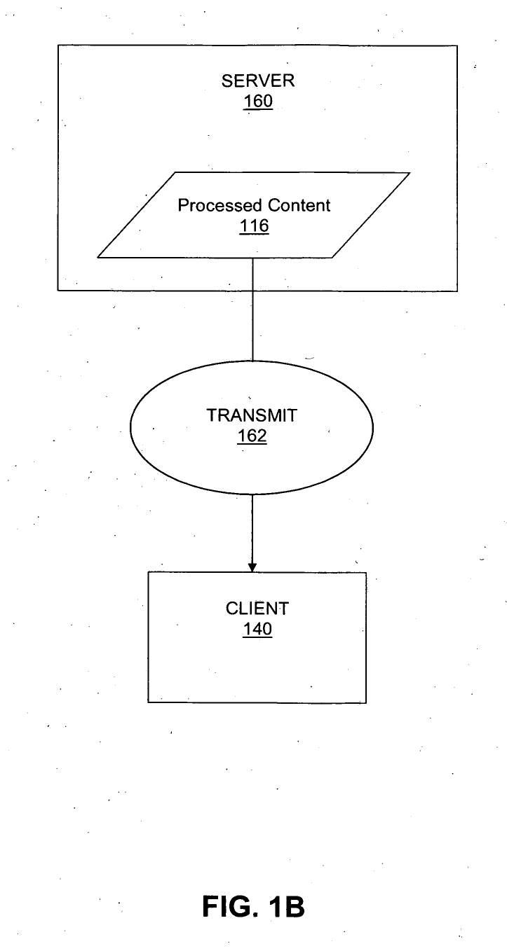

FIG. 1A is a data flow diagram illustrating a use case in accordance with embodiments of the invention. Referring to FIG. 1A, content 106 is output (104) from an application program 102. The content 106 may include various media (e.g., songs, video, graphics, etc.) in one or more of several formats, such as, for example, formats according to the standards for Moving Picture Experts Group (‘MPEG’), Audio Video Interleave (‘AVI’), QuickTime (.mov), Windows Media Video (‘WMV’), DV, Flash Video (‘FLV’), Small Web Format (‘SWF’), Legacy RealMedia (.rm), and so on. The content may output the content of a media file as an output stream. The application program 102 may be executable program code running on a computer, such as, for example, a client device or server device. A server program 110 running on a server device receives the content 106. The application program 102 may be running on the same device as the server 110, or may be coupled to the server device directly or through a network. In some implementations, the application program may comprise an originating client on an originating client device, or may receive content from an originating client, either directly or indirectly. Alternatively, content 106 may also be received from other nodes or retrieved from storage (not shown). The server 110 captures (112) content 106, processes (114) the captured content 106, and transmits (118) the processed content 116 to a client 140 on a client device 150. The client device 150 may be any device capable of consuming media, such as, for example, a computer, a smart phone, a digital media player, an automobile, or any other device having digital audio or video rendering capabilities.

Alternatively, the server 110 may store (120) the processed output 116 in storage 130 for later transmission to the client device 150. In specific embodiments, a first server may capture and process the content, and a second server may transmit the processed output to the client device. In some cases, the processed output may be transmitted after being stored by either the first or second server.

FIG. 1B is a data flow diagram illustrating a use case in accordance with embodiments of the invention. Referring to FIG. 1B, server 160 transmits (162) processed content 116 to client 140. Server 160 may be the same server as server 110, or a separate server. Content 116 may be transmitted directly following processing at server 160 or following transmission from another server, such as, for example server 110; or after being retrieved from storage 130. Client 140 consumes 164 content 116 by rendering content on client device 150.

Transmitting the content according to embodiments of invention provides enhanced distributed content delivery, as discussed in further detail below. Processing is carried out to facilitate enhanced distributed content delivery, by providing processed content 116 which is more readily transmitted in the manner disclosed. Transmitting (162) of server 160 to client 140 allows delivery of high definition media across PC, android, television, and PlayStation3 platforms without downloading third party plug-ins (e.g., FLASH player) or other software. All software for receiving and rendering media on the client device is contained in the browser environment. Playlist strings allow continual stream and progressive delivery manner. Use of distributed storage decreases bandwidth consumption. Data is published in a cloud storage; users retrieve a playlist to redirect browser to specific cloud storage and retrieve a fresh copy of that segment point in the time frame playlist, so bandwidth is not affected and content quality is maximized.

In other embodiments, an embedded device platform in client-side video capture equipment processes the video and segments it from its originating source.

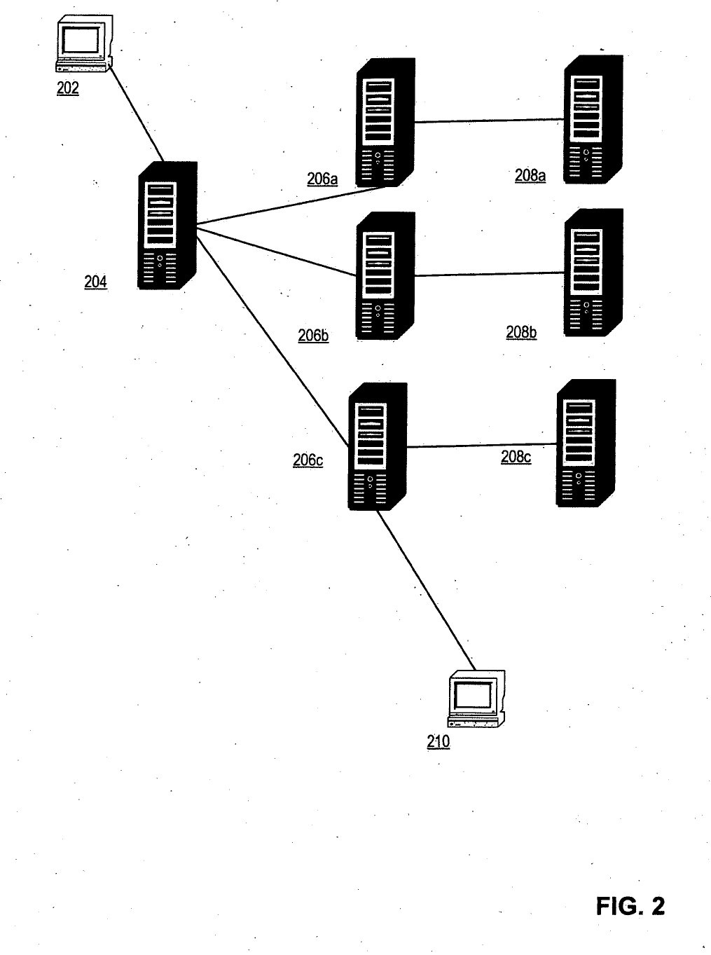

FIG. 2 illustrates a system for enhanced distributed content delivery in accordance with one embodiment of the invention. The system of FIG. 2 includes a source device 202 providing media content as output. The source device 202 is coupled (directly or through a network) to one or more media delivery network servers 204 running a processing module. The media delivery network servers 204 are coupled to regional database servers 206a, 206b, 206c via network. The regional database servers 206a, 206b, 206c provide playlists and serves HTTP files. Regional database servers 206a, 206b, 206c are coupled to regional cloud storage 208a, 208b, 208c via network.

The media delivery network servers 204 include a capture segmenter and various encoders for multi-threaded encoding. The regional database servers 206a, 206b, 206c may also comprise front end functionality for administration and user functionality, a bit rate controller, a database module comprising a playlist signature generator, and a publisher module comprising a frame packet service API. The encoders encode MPEG-4 frames a210s .ts files encoded to multi-device formats and tagged by device format. The bitrate manager strings together encoded .ts files and tags by frame sequence. The publisher generates a playlist from frames and publishes to cloud storage; the publisher also tags the playlist by region of cloud storage and segment.

A client device 210 is connected via networks to an appropriate regional database server 206a, 206b, 206c. Client device may be a smart phone, touchscreen computer, laptop computer, desktop computer, digital media player, automobile, or the like.

Networks may include, alone or in combination, one or more local area networks (‘LANs’), wide area networks (‘WANs’), wired or cellular telephone networks, intranets, or the Internet. Embodiments of the present invention include computer implemented methods operating on any of source device 202, media delivery network servers 204, regional database servers 206a, 206b, 206c, regional cloud storage 208a, 208b, 208c, or computer client device 210, alone or in combination. Embodiments of the present disclosure may include any or all of the devices depicted in FIG. 2.

The devices disclosed in FIG. 2 are provided for illustration and not for limitation. Embodiments of the invention could be implemented as any viable computing device including logic and memory, or software modules including computer program instructions executed thereon, as will occur to one of ordinary skill in the art, including devices where logic is implemented as field-programmable gate arrays (‘FPGAs’), application-specific integrated circuits (‘ASICs’), and the like.

Embodiments of the presently disclosed invention are implemented to some extent as software modules installed and running on one or more data processing systems (‘computers’), such as servers, workstations, tablet computers, PCs, personal digital assistants (‘PDAs’), smart phones, digital media players, and so on. Each of computer source device 202, media delivery network servers 204, regional database servers 206a, 206b, 206c, regional cloud storage 208a, 208b, 208c, or computer client device 210 is typically implemented as a computer.

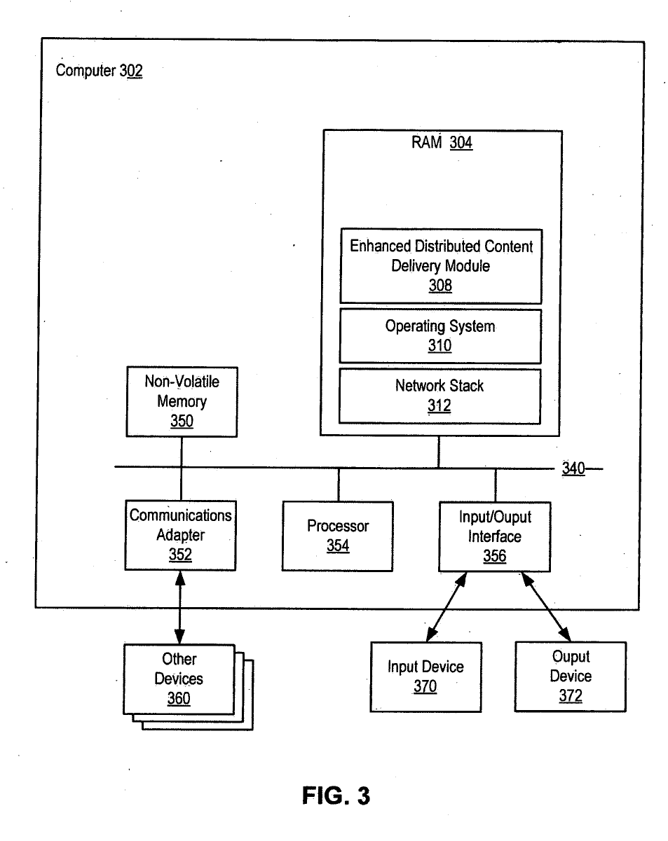

FIG. 3 sets forth a block diagram of an exemplary computer used in embodiments of the present disclosure. Computer 302 includes at least one computer processor 354 as well as a computer memory, including both volatile random access memory (‘RAM’) 404 and some form or forms of non-volatile computer memory 350 such as a hard disk drive, an optical disk drive, or an electrically erasable programmable read-only memory space (also known as ‘EEPROM’ or ‘Flash’ memory). The computer memory is connected through a system bus 340 to the processor 354 and to other system components. Thus, the software modules are program instructions stored in computer memory.

An operating system 310 is stored in computer memory. Operating system 310 may be any appropriate operating system such as Windows XP, Windows Vista, Windows 7, Windows Server, Mac OS X, UNIX, LINUX, or AIX. A network stack 312 is also stored in memory. The network stack 312 is a software implementation of cooperating computer networking protocols to facilitate network communications.

Computer 302 also includes one or more input/output interface adapters 356. Input/output interface adapters 356 may implement user-oriented input/output through software drivers and computer hardware for controlling output to output devices 372 such as computer display screens, as well as user input from input devices 370, such as keyboards and mice.

Computer 302 also includes a communications adapter 352 for implementing data communications with other devices 360. Communications adapter 352 implements the hardware level of data communications through which one computer sends data communications to another computer through a network.

Also stored in computer memory is an enhanced distributed content delivery module 308. The enhanced distributed content delivery module 308 may include device-specific computer program instructions for implementing methods of the present invention. For example, enhanced distributed content delivery module 308 may be implemented, in part, as a web browser application running on a client device operated by a user.

Enhanced distributed content delivery module 308 may also be implemented, in part, as server applications. On each of source device 202, media delivery network servers 204, regional database servers 206a, 206b, 206c, and regional cloud storage 208a, 208b, 208c, enhanced distributed content delivery module 308 has different functionality.

The enhanced distributed content delivery module on regional database servers 206a, 206b, 206c operates to transmit content as described above with reference to FIG. 2 (e.g., etc.). The module 308 may be embedded or installed on media delivery network servers 204.

The enhanced distributed content delivery module on media delivery network servers 204 operates to process content as described above with reference to FIG. 2 (e.g., etc.). The module 308 may be embedded or installed on media delivery network servers 204. The module manages and implements control requests and notifies class drivers on a client device to any data transfer of video segmented frames; and transmits data into a network server container using a standard mpeg-2 transport stream file format. Data ingest of the bitrate data file are multi-threaded encoded and published to the cloud.

In other implementations, the module may be installed or embedded on a recording device, such as a camera. The module may include a set of application modules that manages the recording or capturing device. A capturing application stack operates in conjunction with a corresponding host stack on another system to which the device is connected. The system is designed to manage multiple controllers, implement standard control requests and notify the class drivers of any data transfers initiated by the Host. It provides the necessary abstraction to the class drivers, and interfaces with the controller hardware driver to provide data transfer services over IP capable of a programmable, multiple level response to threshold events received by the capturing application stack embedded on the network camera, input source of satellite feed, third party device enable, or any other typical input.

An application containing the capturing stack embedded on the camera may contain a Segmenter trigger module designed to segment object container video frames according to a sementation strategy, and a strategy model which is programmed and/or configured to adapt the sementation strategy depending on the network conditions. The module may segment video streams into variable second chunks which may be published using a standard MPEG-2 transport stream file format. To maximize the efficiency of the system from affecting network bandwidth, capture functions are configured to transmit frames and/or a “video stream” to a network server via standard digital I/O connections on the system (which may have video publishing triggering capabilities). A standard web browser (such as web browsers that support standard HTTP protocols and are supported by Microsoft Windows operating systems) may be used for all functions. For browser-based access software, camera specific ActiveX controls/Java Applets may be automatically loaded on the end-user device system.

The module may manage multiple controllers, implement standard control requests and notify the class drivers of any data transfers initiated by the Host. The module may also provide the necessary abstraction to the class drivers, and interfaces with the controller hardware driver to provide data transfer services over IP. The API makes facilitates implementation of all of the necessary initialization and callback functions. The Progressive Camera Compression system includes a device stack and controller driver (when available) or a driver development kit. Device side class drivers may support specific cam device types so that the host can recognize and enumerate these devices when they are attached. Available class drivers may include Mass Storage, CDC Abstract Control Model (Serial Emulation) and Ethernet Emulation for Windows connectivity.

For live events, the module responds to changes in network conditions by adjusting the bitrate and the media encoding sequence to optimize the viewing and audio experience of the user.

Processing may include fragmenting media content for storage and delivery from multiple distributed nodes. Fragmentation may be implemented in a variety of ways and carried out in various sizes and formats to provide optimally conditioned fragments for improved content delivery across a wide range of projected network conditions. Some embodiments may involve generating copies of content fragments in multi-codec formats for distribution and consumption worldwide across a wide range of network conditions. Distribution may include multi-threaded delivery from cloud file storage region points.

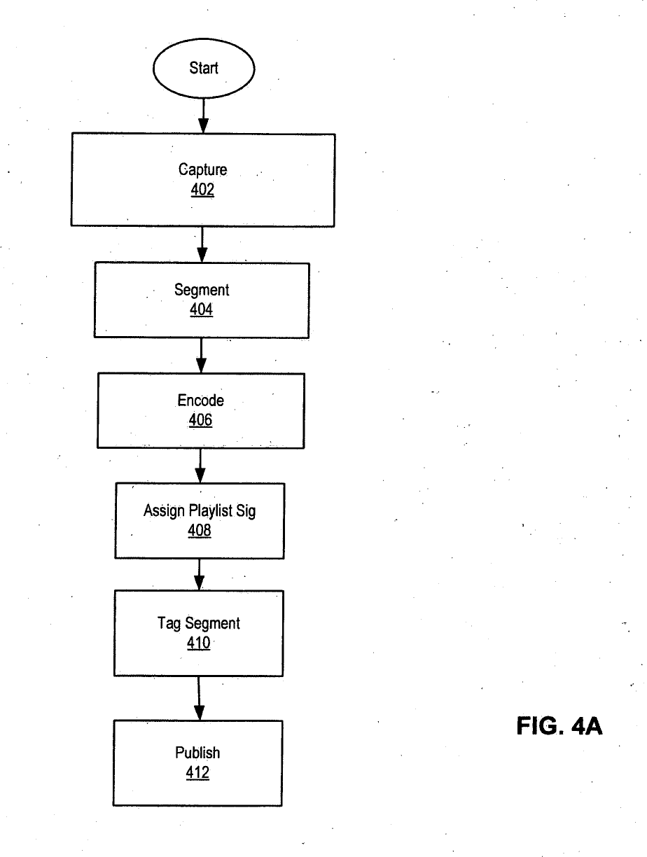

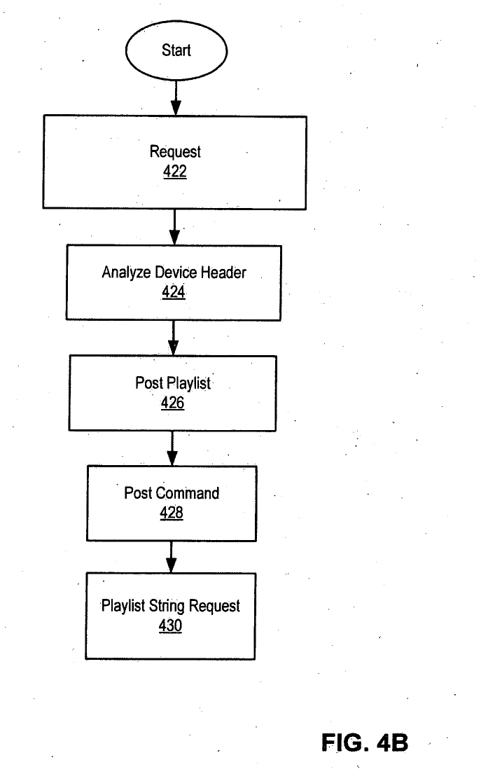

For further explanation, FIG. 4A sets forth a block diagram illustrating a method for enhanced distributed media delivery in accordance with one embodiment of the invention. Referring to FIG. 4A, the method begins by capturing media content output (block 402). After capture, the content is segmented (block 404) and encoded (block 406). Encoding may comprise multi-thread encoding. Next, the system assigns a playlist signature to the segments (block 408) and tags the segments according to frame (block 410). The segments are then published to the cloud (block 412).

Once the data is published, a user may select media by clicking on a link in a web browser. In response, the web browser downloads a playlist from a network server which redirects the browser to a data packet of playlist files in cloud storage, where it is viewed from cache memory.

Some implementations include variations of progressive Hypertext Transfer Protocol (‘HTTP’), where users would request a playlist and retrieve a dynamically generated cache playlist for use in viewing live or on-demand media on any web-enabled device. Transcoding playlist techniques are used, similar to U.S. patent application Ser. No. 12/125,407 to Lee. However, techniques of the present embodiment include segmenting files to encode and publish to cloud file storage. Additionally, playlists are system compiled and encrypted to upload contents to the cloud. Once a user clicks on an HTTP link in a browser, the playlist obtained from the network server redirects to the data packet playlist files from the cloud and views the cache copy. Thus, the platform formats to device player requirements for delivery via HTTP, so no additional downloads, plug-ins, or apps are required.

The HTTP links are directed at frames uploaded to the cloud which play in HD from an embedded player code. The frames may be less than a minute in duration. The playlist requests instruct the cloud file storage to load the playlist in order: playlistset1, then playlistset2, playlistset3 and so on. The system programs the list to operate on retrieving published files from the cloud and playing them in sequence order: playlistset1 retrieves segment pulled from http://cloudfilecontainer1, playlistset2 retrieves segment pulled from http://cloudfilecontainer2; and so on. Cloud distribution allows multiple users to access the playlist at different times and pickup cache playlist copies—minimizing network bandwidth weight on the network server and on the stream.

Encoding of segment frames may involve encoding to four formats and publishing to the cloud. For live events, continuous uploading of a data file can quickly be done if data packets are small and uploaded one at a time.

The server may be configured to process the captured output to achieve constant or relatively constant quality of variable bit rate output upon transmission to the client. The client may be configured to receive transmitted converted output and execute, decode, and/or render graphics, video, and/or audio on the client device. The server may be further configured to process the captured output in order to provide either compressed file size or lower overall average bit rate at low latency. The data may be partitioned into variable-size chunks.

FIG. 4B sets forth a block diagram illustrating a method for enhanced distributed media delivery in accordance with one embodiment of the invention. Referring to FIG. 4B, a user request to view a playlist link (block 422). A request command is issued. Request is sent to the server, where the bitrate controller analyzes the device header (block 424). The post playlist command publishes the playlist to the user (block 426). The Post command redirects the user to published playlist in cloud storage, retrieves frame sequence defined in the device header (block 428). The playlist string request command calls sequence frame from cloud storage container and posts live video (block 430).

Processing may include converting sequences of frame set time blocks in multi-threaded encoding sequences in accordance with multiple formats such as Windows Media Video (‘WMV’), Flash Video (‘FLV’), 3GPP, M3U (m3u8), Moving Picture Experts Group (‘MPEG’), and the like through the use of one or more encoders. An encoder may publish video codec data of converted output in parallel.

Processing may further include configuring multi-pass variable bit rate control of data segmentation, splicing of file packet size into intervals of frame set time blocks, and so on. The server may be configured to control encoding parameters to produce output of relatively constant quality. An encoder may set checkpoints in the second pass to adjust the control parameters and/or subsequent checkpoints. An encoder may define peak bit rate constraints to limit peak bit rate in accordance with client device screen architecture parameters. An encoder may store auxiliary information from earlier passes for use in later passes to increase the performance of the later passes (e.g., to decrease processing time); perform signature encryption of input data and intercept user input decryption to check consistency between passes; and transmit the intercepted user region-defined publishing point of the cloud file storage server over the network internet protocol.

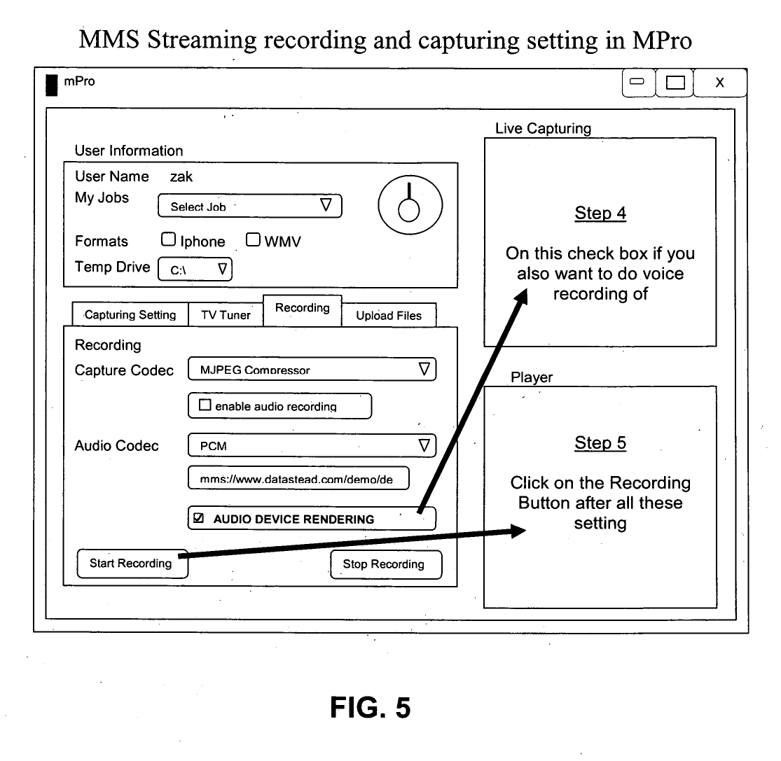

FIG. 5 is a diagram illustrating a graphical display in accordance with one embodiment of the invention.

Embodiments of the present invention include design structures. Such embodiments may be contained on one or more machine readable media as a text file or a graphical representation of hardware embodiments of the invention. Typically, planning design structures are provided as input to design processes used in semiconductor design, manufacture, and/or test, to generate manufacturing design structures, with the exact processes used depending on the type of integrated circuit (‘IC’) being designed, such as an application specific IC (‘ASIC’), a standard component, and so on. A first design structure may be input from an IP provider, core developer, or any other source. A first design structure may include an embodiment of the invention in the form of schematics or a hardware-description language (‘HDL’), e.g., Verilog, VHDL, C, etc. Design processes may be used to translate an embodiment of the invention into a netlist, e.g., a list of wires, transistors, logic gates, control circuits, I/O, models, and so on. These processes may employ automation tools and applications, and may include inputs from a library which may house a set of commonly used elements, circuits, and devices, including models, layouts, and symbolic representations. The netlist describes the connections to other elements and circuits in an IC design, and may also be disposed on a machine readable medium. A netlist may be composed iteratively depending on design specifications and parameters for the circuit.

The design process may translate a planning design structure into a manufacturing design structure that resides on a storage medium in a data format used for the exchange of layout data of integrated circuits (for example, data stored in a GDSII (GDS2), GL1, OASIS, or any other suitable manufacturing design structure format). The manufacturing design structure may comprise information such as, for example, test data files, design content files, manufacturing data, layout parameters, wires, levels of metal, vias, shapes, or any other data required by a semiconductor manufacturer to produce a hardware embodiment of the invention. A producer may then employ the manufacturing design structure in tape-out and manufacture.

The discussion above has focused primarily on embodiments of the invention for use with published segmented media files retrieved according to a modified progressive HTTP. Other embodiments may be used with other file types and data transfer methods. It should be understood that the inventive concepts disclosed herein are capable of many modifications. To the extent such modifications fall within the scope of the appended claims and their equivalents, they are intended to be covered by this patent.

What is claimed is:

1. A method of delivering enhanced distributed media, the method comprising the steps of:
accepting a request;
analyzing a device header;
publishing a playlist to a user;
redirecting the user to a published playlist in cloud storage;
retrieving the frame sequence defined in the device header;
calling frames in order according to the frame sequence; and
posting video defined by frames.

2. The method of claim 1, wherein accepting a request comprises detecting a click on an http link.

3. The method of claim 1, wherein the published playlist is multithread encoded.

4. A method of delivering enhanced distributed media, the method comprising the steps of:
capturing media content output;
segmenting and encoding the captured content;
assigning a playlist signature the resulting segments;
tagging the segments according to frame;
publishing the segments to cloud network; and
at a client station, receiving the media content by way of transmission of the segments from the cloud network

5. The method of claim 4, wherein the encoding step includes multi-thread encoding.

6. The method of claim 4, wherein the receiving step is initiated by a user via a web browser link, whereby the web browser downloads a playlist from a network server and the web browser is redirected to a data packet of playlist files in cloud storage, further including viewing files from cache memory.

7. A method of delivering enhanced distributed media, the method comprising the steps of:
capturing media content output;
segmenting and encoding the captured content;
publishing the encoded segments onto a cloud network; and
transmitting a stream of the media content to a client, by delivering a sequence of the segments from the cloud network.

8. The method of claim 7, further comprising setting block size in response to network conditions.

9. The method of claim 7, further comprising setting block size according to projected network conditions.

10. A method of delivering enhanced distributed media, the method comprising the steps of:
processing digital content to facilitate transmission;
storing processed content;
accessing the digital content according to modified progressive hypertext transfer protocol in accordance with network conditions.
